(19) United States
(12) Patent Application Publication
(10) Pub. No.: US 2008/0134582 A1
(43) Pub. Date: Jun. 12, 2008

(54) Device for Braking the Rotation of a Drive Shaft of the Leaf of a High-Speed Door

(75) Inventor: Bernard Kraeutler, La Villette (FR)

Correspondence Address: CANTOR COLBURN, LLP, 20 Church Street, 22nd Floor, Hartford, CT, 06103, US

(73) Assignee: NERGECO, Dunieres (FR)

(21) Appl. No.: 11/815,399

(22) PCT Filed: Feb. 2, 2006
(86) PCT No.: PCT/FR06/00237

§ 371 Date: Dec. 4, 2007

(30) Foreign Application Priority Data
Feb. 2, 2005 (FR) 0501036
Feb. 17, 2005 (FR) 0501628

(51) Int. Cl. E06B 9/84

(52) U.S. Cl. 49/322

(57) ABSTRACT

The invention relates to a device for braking the rotation of a drive shaft of the leaf of a high-speed door. The inventive device consists of a flange (17) which is rotated by a shaft comprising several cavities (19), each of said cavities being equipped with a wall which supports a flyweight (18) in the operating condition and which is inclined in relation to the axis of rotation of the flange by an angle of less than 90°. Moreover, each cavity comprises a proximal end which is located close to the axis of rotation of the flange and a distal end which is located at a distance from said axis of rotation. According to the invention, each flyweight (18) moves in a cavity between a position whereby the shaft operates at normal speed, in which the flyweight is disposed in a zone comprising the proximal end of the cavity (19), and a position whereby the operating speed of the shaft (4) exceeds a pre-determined threshold, in which the flyweight (18) is disposed in a zone comprising the distal end of the cavity and actuates means for braking the rotation of the shaft.

The present invention relates to a device for braking the shaft of a flexible or rigid and articulated leaf of an industrial, commercial, domestic or garage door.

In order to close an opening made in a partition separating two spaces, it is possible to use a high-speed door having a flexible leaf that rolls up or folds up at the lintel of the door. This type of door has the advantage of being able to open and close very quickly with a speed greater than 0.5 m/s. Such a door is therefore particularly suitable for equipping an opening through which considerable traffic travels.

In order to move the leaf, the door is fitted with a drive train that makes it possible to rotate a shaft on which the leaf can roll up directly or on which straps can roll up that allow the leaf to be folded.

The drive train usually comprises an electric motor which, by means of a reduction gear, rotates the shaft.

Naturally, the elements of the drive train are dimensioned in order to sustain a very large number of cycles. Nevertheless, it is possible to suffer a mechanical breakage in the reduction gear, a breakage of a coupling between the shaft and the reduction gear, etc.

In such a situation, the shaft is no longer controlled; it is then totally free to rotate. Under the effect of gravity, the leaf may then fall violently since the shaft to which the leaf is connected is no longer capable of controlling the fall of the latter.

There is then a risk of an accident if, at the same time as the leaf falls, a person is passing through the door or is in the path of the leaf.

An object of the invention is to propose a braking device for a high-speed door with a flexible leaf protecting the operation of the latter particularly in the case of a mechanical breakage of its drive train.

The essential subject of the invention is a device for braking the rotation of a shaft raising and lowering a leaf of a high-speed door. The device has an endplate rotated by the shaft which has several cavities each of which comprises a wall, which, serving as the support for a weight in operating condition, is inclined relative to the axis of rotation of the endplate at an angle less than 90°, each cavity having a proximal end situated close to the axis of rotation of the endplate and a distal end at a distance from the axis of rotation of the endplate. Each weight travels in a cavity between a position of operation at normal speed of the shaft in which the weight is in a zone comprising the proximal end of the cavity and a position of operation at a speed of the shaft exceeding a predetermined threshold in which the weight is in a zone comprising the distal end of the cavity and actuates means for braking the rotation of the shaft.

The basic idea of the invention is to detect an increase in the rotation speed of the shaft beyond a predetermined threshold. In practice, the increase in the speed of rotation of the shaft occurs in the event of a breakage of an element of the drive train, which causes the shaft to be totally free to rotate and is driven by the weight of the leaf. If the shaft is driven at excess speed, it induces a movement of the weights which actuate braking means.

In a particularly advantageous manner, each cavity has means ensuring a stabilization of the position of the weight in the zone comprising the proximal end of the cavity in operation at normal speed of the shaft and promoting a movement of the weight toward the zone comprising the distal end of the cavity when the speed of rotation of the shaft exceeds a predetermined threshold.

A specific feature of doors with a flexible leaf lies in the fact that it has a high normal speed of operation. The breakage of the drive train induces an excess speed that is however not significantly greater than the speed of normal operation. In other words, the speed differential of the shaft between its normal operation and its abnormal operation is not considerable. It is for this reason that each cavity is fitted with means making it possible to define two systems of operation of the weights, namely a normal operating system in which the weight is kept in a zone comprising the proximal end of the cavity and an abnormal operating system in which the movement of the weight is promoted in order to actuate the braking means.

In one embodiment, each cavity has, on its wall on which the weight presses, in operating condition, a first portion situated on the side of the proximal end having an angle α relative to the axis of rotation of the device and a second position situated on the side of the distal end having an angle β relative to the axis of rotation, the angle β being greater than the angle α and the junction between the first and the second portion forming a protruding zone.

In this embodiment, the weight is kept in the proximal portion of the cavity by the fact that this portion has a relatively acute angle with the axis of rotation of the device and by the fact that the cavity has a protruding zone against which the weight presses. On the other hand, in the event of excess speed of the shaft and, therefore, of the braking device, the centrifugal force applied to the weight causes the latter to pass the protruding zone in order to reach the distal portion of the cavity. This distal portion, which has a less acute angle than the proximal portion, offers little resistance to the weight which can then actuate the braking means.

In another embodiment, each cavity has, on its wall on which the weight presses in operating condition, a rib which separates the distal end from the proximal end, a rib on which the weight presses in normal operation of the door. The presence of this rib may be combined with the feature by which the proximal and distal portions have angles that accentuate radially.

In another embodiment, breakable means keep the weight at the proximal end of the cavity, these breakable means capable of breaking in abnormal operation of the door releasing the weight toward the proximal end of the cavity.

It is possible to envisage that the breakable means consist of a wire whose strength makes it possible to sustain the centrifugal force applied to the weight in operation at normal speed of the shaft but does not make it possible to sustain the centrifugal force applied to the weight in abnormal operation.

According to one possibility, the braking means comprise a radially or axially movable assembly on which the weights act and a fixed assembly with which the movable assembly may come into contact by friction and/or meshing to brake the rotation of the shaft.

In one embodiment, each cavity receiving a weight has, at its distal end, a radially movable finger that can occupy a retracted position in which the finger is retained by a spring or can occupy a protruding position under the effect of a pressure by a weight, the finger in the protruding position being able to engage in an opening arranged in a fixed disk. This embodiment has the advantage of involving only a reduced number of moving parts.

In another embodiment, each cavity receiving a weight is delimited by the wall arranged in the endplate by a wall of an assembly that can move axially between a position of operation at normal speed in which the movable assembly is pushed in the direction of the cavity by elastic means and a position of operation at a speed exceeding a predetermined threshold in which each weight axially pushes the movable assembly against a fixed disk. In this embodiment, the movement of the weights is converted into an axial movement of a movable assembly which blocks the device by interacting with a fixed disk.

The braking may then be achieved thanks to the feature by which the movable assembly has, on a wall opposite to its wall facing the cavity, at least one tooth capable of engaging in a tooth protruding from a fixed disk.

Preferably, the teeth of the movable assembly and the teeth of the fixed disk are undercut and are disengaged after their engagement only by a reverse rotation of the shaft. Therefore, it is necessary for there to be human intervention in order to release the rotation of the shaft.

The blocking may also be achieved thanks to the feature by which the axially movable assembly has, on its wall opposite to its wall facing each cavity, a convergent frustoconical ring on which at least one pivoting lever presses having a hook at its free end, the lever being able to pivot between a position of operation at normal speed of the shaft and a position of operation at a speed of the shaft exceeding a predetermined threshold in which the ring presses on each lever in order to cause it to pivot until it catches on a fixed bar.

It is also possible to envisage the provision of a slowing of the rotation of the device before it is completely braked. Accordingly, the axially movable assembly has, on its wall opposite to its wall facing the cavity, a pad for braking the rotation by friction against a fixed element.

In order to ensure its axial movement relative to its spindle, the device comprises a linear ball bearing making it possible to cause the movable assembly to slide relative to the spindle.

Note also that the device may comprise means of connection with a control unit making it possible to transfer a triggering of the device.

For it to be well understood, the invention is described with reference to the drawing appended hereto representing, as a nonlimiting example, several embodiments of a braking device according to the latter.

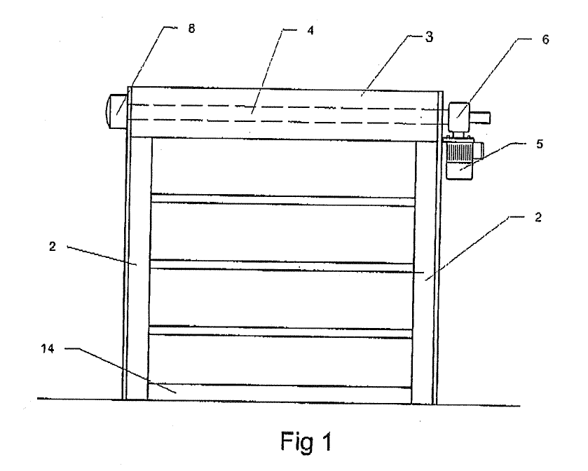

FIG. 1 represents schematically a door fitted with a braking device acting on a shaft when the speed of rotation of the shaft exceeds its normal operating speed,

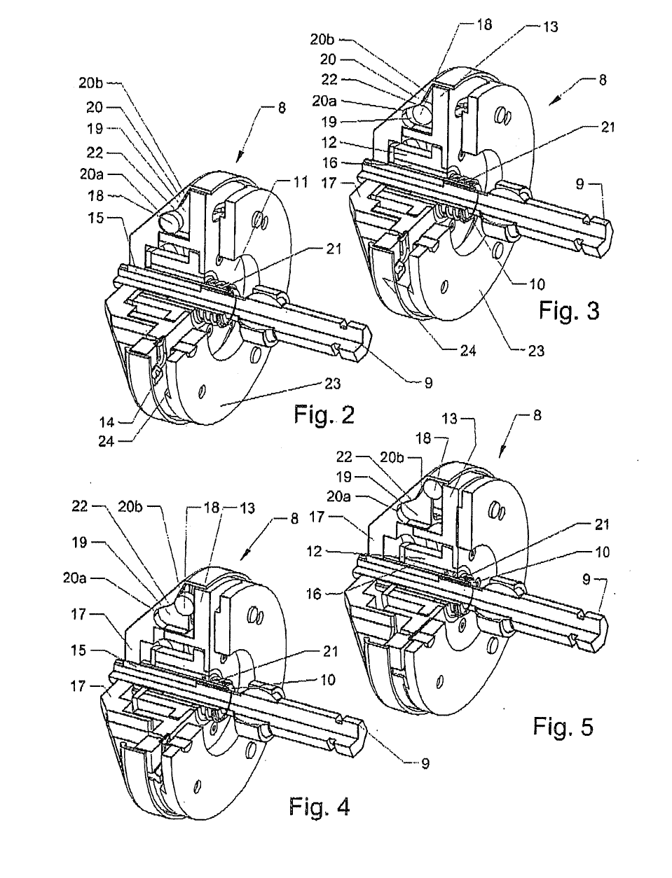

FIGS. 2 to 5 represent in perspective, with a partial section, an embodiment of the braking device in several operating configurations of the latter,

FIGS. 6 to 9 represent in perspective, with a partial section, another embodiment of the braking device in several operating configurations of the latter,

FIG. 10 represents, on a larger scale, a detail of the braking device represented in FIGS. 6 to 9,

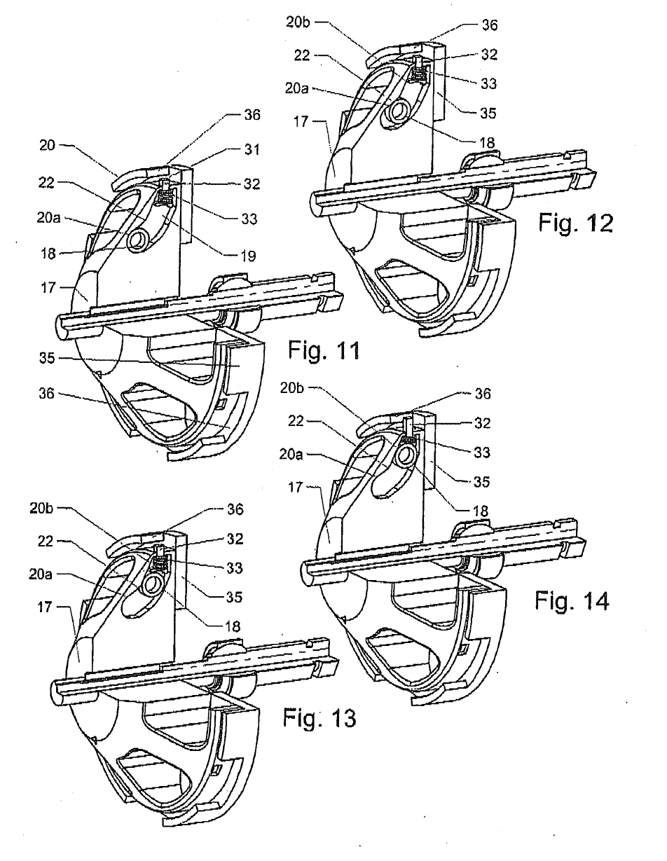

FIGS. 11 to 14 represent in perspective, with a partial section, another embodiment of the braking device in several operating configurations of the latter.

For simplification, the elements that are in these various embodiments, or that are the same from one embodiment to another, are indicated by the same reference numbers.

In a conventional manner, a high-speed door designed to close an opening in a partition has two uprights 2 that are usually connected each at their top end by a transverse cover 3.

One of the uprights 2 supports means for driving a shaft 4 that are inside the transverse cover 3. The drive means usually comprise an electric motor 5 and a reduction gear 6 which provide the connection with the shaft 4.

In the example shown of the door, a leaf 6 is suspended on the shaft 4; the leaf 6 rolls up on the shaft 4 in order to open the passageway and unrolls from the shaft 4 in order to close the passageway.

Another method of moving the leaf consists in suspending the leaf from the uprights 2 and in providing straps one end of which is connected to the shaft 4 and the other end is connected to the threshold of the leaf. When the shaft 4 rotates, the straps roll up on the shaft and therefore raise the leaf which folds up beneath the transverse cover.

The specific feature of the door according to the invention lies in the fact that a braking device 8 is placed at the end of the shaft.

Reference should be made first of all to FIGS. 2 to 5 which illustrate a first embodiment of the device. As shown in FIG. 2, the braking device 8 has a spindle 9 which, at its free end, has a hexagonal section; the latter may be engaged in a housing of similar section made in the shaft 4 of the door.

The device has an axially movable assembly 11 that is rotated with the spindle 9.

This movable assembly 11 comprises a sleeve 10 that is engaged on the spindle 9 and is fixedly attached to the latter by a cotter 15. Axially, the sleeve 10 is stopped by an elastic ring.

The sleeve 10 receives a supporting sleeve 12 to which a disk 13 is attached. This disk 13 is fitted with several radial teeth 14 whose function will appear below. Note, however, that the teeth 14 have an undercut profile.

A point that it is important to note is that a linear ball bearing 16 is interposed between the sleeve 10 and the intermediate sleeve 12.

Therefore, the movable assembly 11 is rotated by the spindle 9 and is capable of having an axial movement thanks to the linear ball bearing 16. The axial movement of the movable assembly 11 is limited by a spring 21 placed coaxially with the spindle 9.

An endplate 17 engaged on the spindle 9 makes it possible to enclose several weights 18—in the example shown, the weights 18 are six in number—that press against the disk 13 of the movable assembly 11. As can be seen in the figures, each weight 18 is enclosed in a cavity 19. The cavity 19 is, in the exemplary embodiment shown, delimited by a wall of the movable assembly 11 and by a wall 20 arranged in the endplate 17. This wall is very characteristic since, as can be seen, it has two successive portions, namely a proximal portion that is close to the axis of rotation of the spindle 9 and a distal portion 20a that is at a distance from this same axis. The endplate 17 is fixedly attached in rotation to the spindle 9 by the cotter 15.

The specific feature of the wall 20 is that the distal portion 20a forms a first angle with the axis of rotation and the proximal portion 20b forms a second angle with the axis of rotation, this second angle being greater than the first.

Note also that a protruding zone 22 separates the distal portion from the proximal portion.

The device also has a fixed assembly which, in the example shown, is a disk that has four teeth having an undercut profile.

The operation of the braking device is therefore as follows.

FIG. 2 shows the device at rest, the weight 18 then rests at the proximal end of the cavity 19.

When the door is in action and, therefore, the shaft 4 is rotating to raise or lower the curtain 6, the weight 18 is subjected to a centrifugal force which therefore moves it away from the axis of rotation and presses it against the protruding zone 22 of the wall 20 of the cavity 19. This normal operating state of the door is illustrated by FIG. 3.

On the other hand, if the speed of rotation increases beyond a predetermined threshold, the centrifugal force that increases due to the speed pushes the weight 18 beyond the protruding zone 22 of the cavity 19. FIG. 4 shows this state.

The weight 18 then presses on the distal portion of the cavity. The latter has a relatively obtuse angle; the weight 18 joins the distal end of the cavity 19 and pushes the movable assembly toward the fixed disk.

As is then shown in FIG. 5, the respective teeth 14, 24 of the movable assembly 11 and of the fixed disk 23 engage and form a mechanical connection between the movable assembly 11 and the fixed disk 23 then locking the rotation of the device and hence of the shaft.

FIGS. 6 to 9 show a variant embodiment of the device which also has an assembly 25 that can be moved axially under the action of the weights 18. The main difference from the movable assembly previously described is that the movable assembly 25 has, on its wall opposite to its wall facing the cavity 19, a frustoconical ring 26.

The means allowing the axial movement of the movable assembly 25 are similar to those allowing the movement of the movable assembly 11 and the endplate 17 with its cavities 19 enclosing weights 18 is similar to that of the device of FIGS. 2 to 5.

It can also be seen that levers 27 are fitted onto the braking device. These levers 27 are eccentric relative to the axis of rotation and may pivot relative to respective spindles 28, parallel to the axis of rotation of the device. Each lever 27 has, at its free end, a hook 30.

Note also that several fixed bars 29, six in number in the example illustrated, are placed around the braking device.

The operation of the device in this embodiment is as follows.

FIG. 6 shows the device at rest; the weight 18 then rests against the proximal end of the cavity.

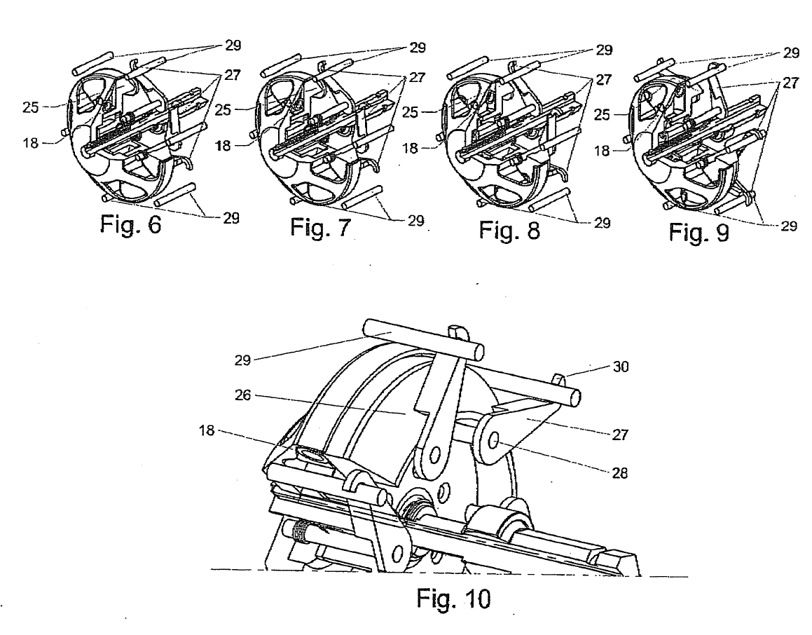

FIG. 7 shows the device in the normal operating system; the weight 18 is then resting against the protruding zone 22 of the cavity and against the wall of the movable assembly 25.

FIG. 8 shows the device at the beginning of the abnormal operating system, that is to say in the event of excess speed of the shaft of the door; the weight 18, pushed by the centrifugal force, passes beyond the protruding zone 22 and then pushes the movable assembly 25 in an axial direction.

FIG. 9 then illustrates the movement of the movable element. This movement has the effect of producing a rotation of the levers 27 because the frustoconical ring acts as a ramp on which the levers 27 rest. During rotation, each lever 27, thanks to its hook 28, catches on a fixed bar 29, which stops the rotation of the device and therefore of the shaft 4. The device then stops the rotation of the shaft 4.

The device of FIGS. 10 to 14 differs from the two preceding embodiments to the extent that a movable assembly 31 moves radially.

In this embodiment, there is an endplate 17 in which several cavities 19 are arranged enclosing weights. Each cavity 19, like the cavities of the two preceding embodiments, has a proximal portion 20a and a distal portion 20b separated by a protruding zone 22, the distal portion forming a more open angle with the axis of rotation than the proximal portion.

As concerns the braking means, the latter consist of a radially movable element 31 that can interact with a fixed element.

The movable element 31 has a radially movable finger 32 that can occupy a retracted position 31 in which the finger 32 is kept by a spring 33 in a protruding position in the case of the spring 33 being compressed.

The fixed element is, in the example shown, a fixed ring 35 in which radial openings 36 are made.

FIG. 11 shows the device at rest, the weight 18 is then against the proximal end of the cavity.

FIG. 12 shows the device in the normal operating system; the weight 18 is resting against the protruding zone 22 of the cavity.

FIG. 13 shows the device at the beginning of the abnormal operating system, that is to say in the event of excess speed of the shaft 4 of the door, the weight passes beyond the protruding zone 22 and comes to press on the finger 32.

FIG. 14 illustrates the pressure exerted by the weight 8 on the finger 32 which causes the latter to protrude radially. The finger 32 then engages in a hole of the ring, which has the effect of blocking the rotation of the device and hence of the shaft.

It should be noted that the cavity 19 may include an elastic means such as an elastic flexible strip that holds the weight in the proximal portion of the cavity, when the door operates in the normal system.

The invention therefore provides a braking device which, in its various embodiments, makes it possible to effectively stop the rotation of a shaft of a door, when there is a breakage of the drive train of the latter.

The invention specially provides a braking device that can be adapted to flexible curtain doors whose speed of rotation of the shaft in normal operation and in abnormal operation is quite close.

Naturally, the invention is not limited to the embodiments described above as nonlimiting examples, but on the contrary it embraces all the embodiments thereof.

1. A device for braking a rotation of a shaft for raising and lowering a flexible or rigid and articulated leaf of a high-speed, industrial, commercial, domestic or garage door, comprising it has an endplate rotated by the shaft having several cavities each of which comprises a wall, which, serving as a support for a weight in operating condition, is inclined relative to an axis of rotation of the endplate at an angle less than 90°, each cavity having a proximal end situated close to the axis of rotation of the endplate and a distal end at a distance from the axis of rotation of the endplate, each weighty traveling in a cavity between a position of operation at normal speed of the shaft in which the weight is in a zone comprising the proximal end of the cavity and a position of operation at a speed of the shaft exceeding a predetermined threshold in which the weight is in a zone comprising the distal end of the cavity and actuates means for braking the rotation of the shaft.

2. The braking device as claimed in claim 1, wherein each cavity has means ensuring a stabilization of the position of the weight in the zone comprising the proximal end of the cavity in operation at normal speed of the shaft and promoting a movement of the weight toward the zone comprising the distal end of the cavity when the speed of rotation of the shaft exceeds a predetermined threshold.

3. The braking device as claimed in claim 2, wherein each cavity has, on a wall on which the weight presses, in operating condition, a first portion situated on the side of the proximal end having an angle α relative to the axis of rotation of the device and a second position situated on a side of the distal end having an angle β relative to the axis of rotation, the angle β being greater than the angle α and a junction between the first and the second portion forming a protruding zone.

4. The braking device as claimed in claim 2, wherein each cavity has, on a wall on which the weight presses in operating condition, a rib which separates the distal end from the proximal end, a rib on which the weight presses in normal operation of the door.

5. The braking device as claimed in claim 2, wherein breakable means keep the weight at the proximal end of the cavity, these breakable means capable of breaking in abnormal operation of the door releasing the weight toward the proximal end of the cavity.

6. The braking device as claimed in claim 5, wherein the breakable means comprise a wire whose strength makes it possible to sustain a centrifugal force applied to the weight in operation at normal speed of the shaft but does not make it possible to sustain a centrifugal force applied to the weight in abnormal operation.

7. The braking device as claimed in claim 1, wherein the braking means comprise a radially or axially movable assembly on which the weights act and a fixed assembly with which the movable assembly may come into contact by friction and/or meshing to brake the rotation of the shaft.

8. The braking device as claimed in claim 7, wherein each cavity receiving a weight has, at its distal end, a radially movable finger that can occupy a retracted position in which the finger is retained by a spring or can occupy a protruding position under the effect of a pressure by a weight, the finger in the protruding position being able to engage in an opening arranged in a fixed rings.

9. The braking device as claimed in claim 7, wherein each cavity receiving a weight is delimited by the walls of an assembly that can move axially between a position of operation at normal speed in which the movable assembly is pushed in a direction of the cavity by elastic means and a position of operation at a speed exceeding a predetermined threshold in which each weight axially pushes the movable assembly against a fixed element.

10. The braking device as claimed in claim 9, the movable assembly has, on a wall opposite to its wall facing the cavity, at least one tooth capable of engaging in a tooth protruding from a fixed disk.

11. The braking device as claimed in claim 10, wherein the teeth of the movable assembly and the teeth of the fixed disk are undercut and are disengaged after their engagement only by a reverse rotation of the shaft.

12. The device as claimed in claim 7, wherein the axially movable assembly has, on its wall opposite to its wall facing each cavity, a convergent frustoconical ring on which at least one pivoting lever presses having a hook at its free end, the lever being able to pivot between a position of operation at normal speed of the shaft and a position of operation at a speed of the shaft exceeding a predetermined threshold in which the frustoconical ring presses on each lever in order to cause it to pivot until it catches on a fixed bar.

13. The braking device as claimed in claim 9, wherein the axially movable assembly has, on its wall opposite to its wall facing the cavity, a pad for braking the rotation by friction against a fixed element.

14. The braking device as claimed in claim 9, further comprising a linear ball bearing making it possible to cause the movable assembly to slide relative to the spindle.

15. The braking device as claimed in claim 1, further comprising means of connection with a control unit making it possible to transfer a triggering of the device.
